(19) United States
(12) Patent Application Publication
(10) Pub. No.: US 2012/0185672 A1
(43) Pub. Date: Jul. 19, 2012

(54) LOCAL-ONLY SYNCHRONIZING OPERATIONS

(75) Inventors: Alan Gara, Mount Kisco, NY (US); Martin Ohmacht, Yorktown Heights, NY (US); Burkhard Steinmacher-Burow, Boeblingen (DE); Robert W. Wisniewski, Ossining, NY (US)

(73) Assignee: INTERNATIONAL BUSINESS MACHINES CORPORATION, Armonk, NY (US)

(21) Appl. No.: 13/008,498

(22) Filed: Jan. 18, 2011

(51) Int. Cl. G06F 9/30

(52) U.S. Cl. 712/30; 712/E09.032

(57) ABSTRACT

Performing a series of successive synchronizing operations by a core on data shared by a plurality of cores may include a first core indicating an upcoming synchronizing operation on shared data. A second memory layer stores the shared data and tracks the first core's ownership of the shared data. The second memory layer is shared via coherency operations among the first core and one or more second cores. The first core may perform one or more synchronization operations on the shared data without requiring interaction from the second memory layer.

### CROSS-REFERENCE TO RELATED APPLICATIONS

This application is related to U.S. patent application Ser. No. ______ filed on ______ entitled LOCAL SYNCHRONIZATION IN A MEMORY HIERARCHY (Attorney docket AUS920100323US1), which is incorporated herein by reference in its entirety.

### STATEMENT REGARDING FEDERALLY SPONSORED RESEARCH OR DEVELOPMENT

This invention was made with Government support under Contract No.: B554331 awarded by Department of Energy. The Government has certain rights in this invention.

### FIELD

The present application generally relates to computer architecture and more particularly to synchronizing operations in hardware processor execution in multi-core computer processing systems.

### BACKGROUND

The number of cores working in parallel is increasing. Whether the cores are on a symmetric multiprocessing (SMP) machine or within a single chip, they need an efficient way to perform synchronization. Many modern architectures provide atomic primitives that allow the cores to efficiently synchronize. Even still, as the number of cores increases, to achieve good performance, software needs to, as much as possible, perform local operations. At this scale, global (across the cores of a chip) operations prevent the software from utilizing the full capability of the machine, and in some cases perform almost no better than running on a single core. Thus software architects have to work to design techniques allowing the vast majority of operation to be local (to the core) only. However, current hardware mechanisms perform atomic synchronization at the L2 or L3, which are a far distance from the core, but not the L1, which is physically and temporally close to the core.

### BRIEF SUMMARY

A method and apparatus for local-only synchronizing operations may be provided. In one aspect, the method for local-only synchronizing operations may include performing a series of successive synchronizing operations by a core on data shared by a plurality of cores, for example, including a first core indicating an upcoming synchronizing operation on shared data and a second layer of memory that stores the shared data tracking the first core's ownership of the shared data. The second layer of memory is shared via coherency operations among the first core and one or more second cores. The method may also include the first core performing one or more synchronization operations on the shared data without requiring interaction from the second layer of memory.

A system for performing a series of successive synchronizing operations by a core on data shared by a plurality of cores, in one aspect, may include a plurality of cores on one or more chips, each of the plurality of cores having an associated first layer of memory. The plurality of cores may be operable to indicate an upcoming synchronization operation on shared data. A second layer of memory may be shared between the plurality of cores and operable to store the shared data. The second layer of memory further may be operable to keep track of which core currently owns the shared data. The plurality of cores may be operable to perform one or more synchronization operations on the shared data without requiring interaction from the second layer of memory by bringing in the shared data from the second layer of memory to the first layer of memory.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating local only atomic operations in one embodiment of the present disclosure.

FIG. 2 is a diagram illustrating local only atomic operations in another embodiment of the present disclosure.

FIG. 3 is a diagram illustrating local only atomic operations in yet another embodiment of the present disclosure.

FIG. 4 is a flow diagram illustrating a method of performing a series of successive synchronizing operations by a core on data shared by a plurality of cores in one embodiment of the present disclosure.

### DETAILED DESCRIPTION

A mechanism is disclosed in one embodiment to allow successive atomic operations to the same address to be handled by a core locally (i.e., L1), and only fall back to going to the shared cache memory (L2) if some other core starts performing operations on the address.

A core may include a logical execution unit containing functional units and a cache memory local to it (e.g., L1 cache) and can independently execute program instructions or threads. An integrated circuit die (IC, also referred to as a chip) may contain multiple of such cores. Generally a memory hierarchy includes a plurality of memory levels which a core may utilize for performing its functions: register files used by the core; a memory local to a core (L1 cache memory) requires the least number of cycles for the core to access (therefore, its is referred to as being closest to the core); the next level of memory may be an L2 cache memory which takes more number of cycles to access and is placed further distance away from the core than the L1 cache memory that is local to the core. L2 cache memory may be shared among a number of different cores, for instance, on the same IC or different IC. A person of ordinary skill in the art will understand that the memory hierarchy further extends to other levels of memory such as L3 memory, main memory, storage discs, and others. Generally, moving farther away from the core, the memory in the level successively becomes larger but slower to access for the core.

For the rest of this description L2 is used to represent the level in the cache hierarchy where coherency is performed. However, one skilled in the art will recognize that on some chip architectures this occurs at the L3 or other level, and thus for those architectures, L2 in the below embodiment may be substituted L3 or level at which coherency is performed. Briefly, cache coherency refers to consistency in data stored in local cache memory and shared cache memory.

An atomic operation is a sequence of one or more machine instructions that are executed sequentially, without interruption. Atomic operations must appear to have executed as if they were not broken up into smaller parts such that another core's instruction is scheduled in between the parts of the atomic operation. If the sequence of instructions is interrupted, the atomic operation fails and another attempt is made to perform the sequence of instruction as an atomic operation.

A method in one embodiment of the present disclosure allows successive atomic operations to the same address to be performed at the L1 memory hierarchy level. Normally the reservation for data for atomic operations is kept at the L2 memory. For instance, load and store (e.g., lwarx (load with reservation)/stx (store conditional)) atomic operations are performed at the L2 memory hierarchy level. Briefly, lwarx and stx are atomic operations of PowerPC (Performance Optimization with Enhanced RISC—Performance Computing) that perform load and store atomically. Instead, the present disclosure in one aspect discloses keeping only an entry in the L2 indicating that a particular core is performing a synchronizing operation.

In particular, when a given core attempts to perform an atomic operation, the following may occur. Assuming no other core is accessing the requested address the L2 makes a note over what core now owns the address and communicates back to the L1 of the requesting core that that L1 now owns this address. While in this state, successive synchronizing operations can be performed at the L1 considerably improving performance and not contending over the bus connecting L1 and L2 memories. At some point, the address may be evicted from the L1 cache, either because the software indicates it has finished with that address or due to capacity or other such reasons.

At this point, the L2 updates the ownership information to be back at the L2. In the event that another core makes a synchronizing request while an address is owned by another core, the L2 fails that request similar to what happens now when two cores collide on synchronizing instructions at the L2, and makes a request to the owning L1 to take ownership back to the L2. The new requesting core will request the address again and then it will be granted ownership. Alternatively, the L2 can synchronously request ownership back from the original owning core and immediately, without additional requests, transfer ownership to the requesting core. Fairness information is also kept at the L2 to ensure that a single core or subset of cores does not starve another or another subset of cores.

The above-described mechanisms perform significantly better if the common case is many successive synchronizing operations on a given core. In the case that synchronizing operations are scattered across cores, the mechanism may revert back to known atomic operation mechanism in which those operations take place in L2. The decision may be made by providing control to the software to choose the mechanism or by monitoring the behavior in hardware and switching between the different states based on the observed reference pattern, specifying which core are performing atomic operations and when.

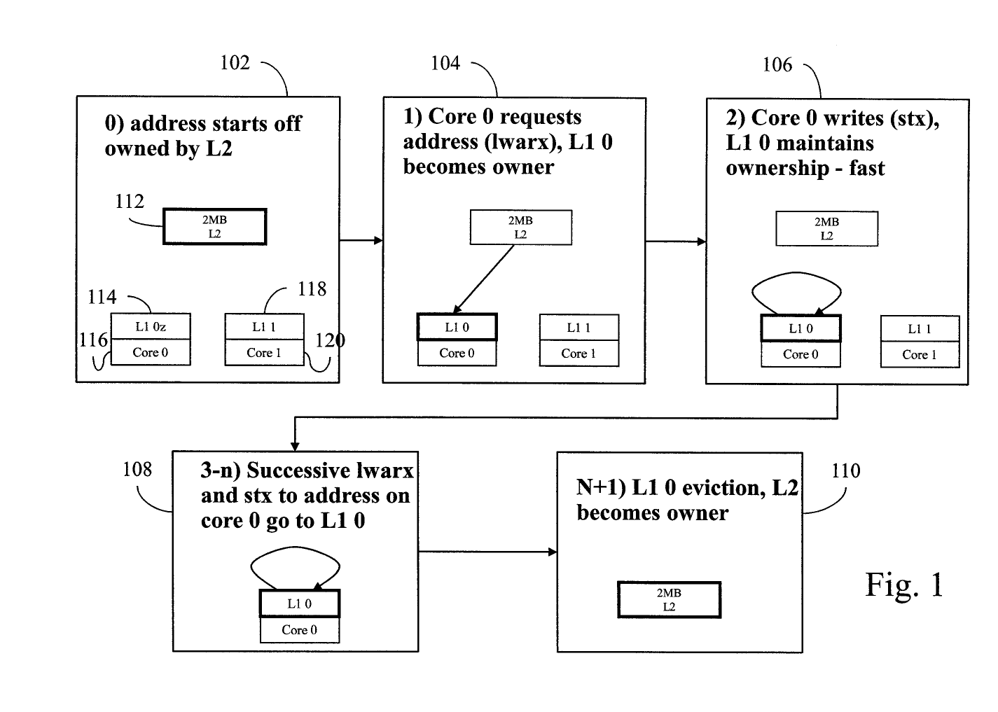

FIG. 1 is a diagram illustrating local only atomic operations in one embodiment of the present disclosure. Generally, multi-core chip (integrated circuit die) architecture includes a plurality of cores 116, 120 each having its own (local) cache memory (e.g., L1 cache) 114, 118, also referred to as a first layer memory. A core is an independent execution unit and may include functional units as well as an L1 cache. A chip also includes a second layer memory (e.g., L2 cache) 112 that is shared among the plurality of cores 116, 120. The cores may be connected by a bus to the shared L2 memory. The distance from a core to its L1 memory is shorter than the distance to the L2 memory on the chip, i.e. It follows that accessing a core's L1 memory takes less time than accessing an L2 memory on the chip for a given core. In the present disclosure the terms first memory layer, first layer memory, first layer of memory interchangeably refer to cache memory that is local to a core, e.g., L1 cache memory implemented on a core. In the present disclosure the terms second memory layer, second layer memory, second layer of memory interchangeably refer to cache memory that is shared among a plurality of cores and where cache coherency is maintained.

Generally, atomic operations have been implemented at the second layer memory, the first point of commonality between/among the plurality of cores. The methodology of the present disclosure in one embodiment provides for ownership to be transferred to the L1 such that the first layer memory in effect gets to temporarily own (be a point of contact) for the data, with the L2 tracking the ownership. In this way, the next atomic operation performed by the same core (owning the data) will fetch the data from L1, instead of going out to L2. Referring to FIG. 1, an address is initially owned by a second layer memory (L2) 112 as shown at 102.

At 104, a core (e.g., core 0) requests an address (access to data stored in the address) in L2 112, which may shared between the cores, for instance, by issuing an atomic load operation such as “lwarx”. Briefly, lwarx (load word and reserve indexed) is a PowerPC assembler instruction for loading with reservation. Provided that no other cores are requesting the same address, L2 makes the requesting core the owner of this address by recording a bit setting indicating ownership associated with the address. For example, a number of bits may be allocated for identifying a current core that owns the address. For instance, a bit setting of 0000 may indicate that core 0 is the owner; a bit setting of 0001 may indicate that core 1 is the owner, etc. Any other identifying mechanism may be employed. The number of bits needed is logarithmically proportional to the number of core. The data from the requested address is brought into core 0's L1, i.e., the first layer memory. Thus, in response to the load atomic operation, the first layer memory (L1) of the core becomes the current owner of that address.

At 106, core 0 performs writes to the address, for example, by issuing a store (e.g., “stx”) command. Stx (store word indexed) is a PowerPC assembler instruction that performs a conditional store. The write is done in the first layer memory and the first layer memory maintains the ownership of that address.

At 108, successive lwarx and stx atomic operations to the same address on core 0 are performed at the first layer memory (L1) of the core 0. At 110, after L1 is evicted of, or relinquishes its ownership of the address, the second layer memory (e.g., L2) becomes the owner again. For instance, a bit setting at L2 associated with the address is set as L2 being the owner.

FIG. 1 illustrates how successive atomic operations performed by an individual core achieve better performance by allowing the data referenced by the atomic operation to stay resident in the L1. The next two diagrams illustrate what happens when there is contention (more than one core trying to concurrently access) for the data.

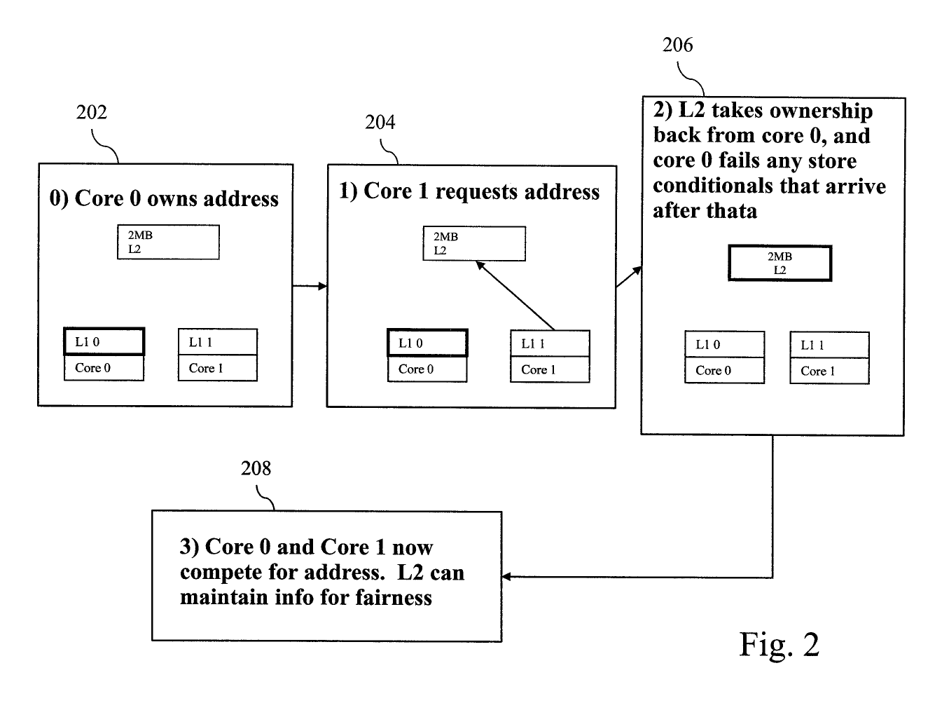

FIG. 2 is a diagram illustrating local only atomic operations in another embodiment of the present disclosure. At 202, core 0 currently owns the address. That is, the data stored in shared second layer memory is accessed by core 0 and as a result becomes an owner of the data as illustrated in FIG. 1. The second layer memory has a record of the current owner of that address.

At 204, core 1 requests the address. That is, core 1 tries to access the data of that address in the second layer memory. At 206, the second layer memory takes ownership back. It does so by sending a reclaim message to the L1. Any store conditionals that arrive at the L1 of core 0 after ownership has been reclaimed by the L2 fail. In one embodiment, ownership may be identified by both of the following. The L2 has a bit setting which indicates what core owns the cache line of the data, and the L1 has a marking on the cache line indicating that it has exclusive write access.

At 208, core 0 and core 1 now compete for the address. It is possible the address ping-pongs between core 0 and core 1 without either of them being able to write a value. This is particularly true if there are many other cores also requesting atomic access to this address. It is possible under these competitive conditions that one or more of the cores are able to gain any access to the data. Thus, the present embodiment allows for fairness information to be kept at L2 to ensure that each core requesting atomic access to the address is granted access in a time commensurate with the number of other cores requesting access. In more detail, the second layer memory may keep track of which cores are requesting the shared data as to ensure fairness to all requesting cores in providing access of the shared data. For instance, a queue may be maintained at L2, which identifies the requesting cores. A first-in-first-out methodology may be used in conjunction with the queue to allow the cores to access the shared data L2 in a first-come-first-serve basis.

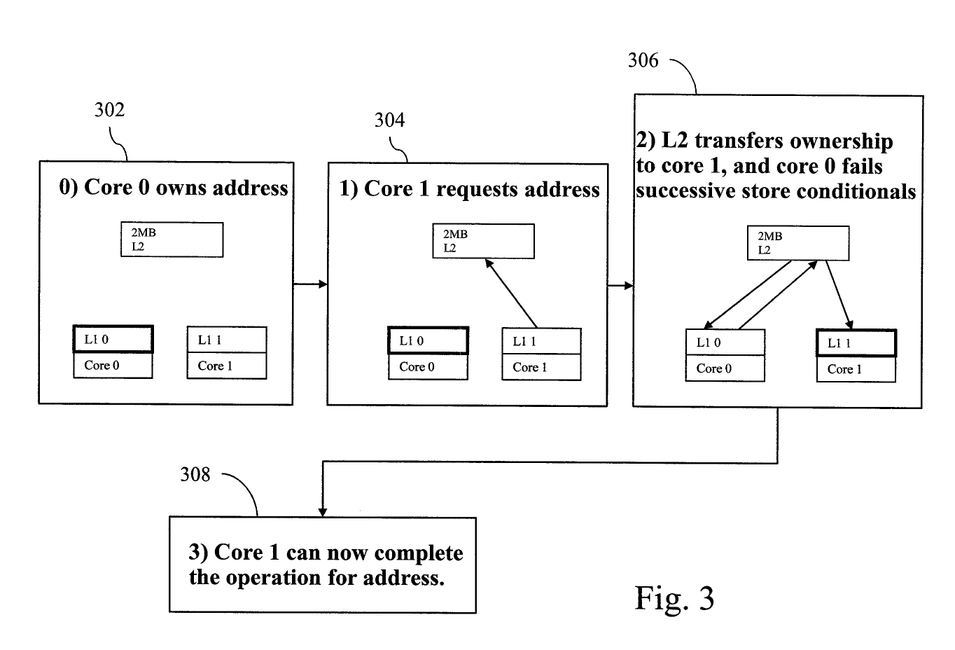

FIG. 3 is a diagram illustrating local only atomic operations in yet another embodiment of the present disclosure. At 302, core 0 owns the address. That is, the data stored in shared second layer memory (L2) is accessed by core 0 and as a result becomes an owner of the data as illustrated in FIG. 1. The second layer memory has a record of the current owner of that address. For example, bit settings indicating core 0 may be recorded in an allocated portion of the second layer memory.

At 304, core 1 requests to access the data at the address. At 306, the second layer memory transfers ownership to core 1, copying the data, if modified (as indicated by a modified bit) in core 0's L1 back to the second layer memory, and core 0 fails any successive store conditional operations. Then the request by core 1 to copy the data at the address to its first layer memory (L1) proceeds. L2 records that the current owner is core 1, for instance, by recording appropriate bit settings in L2. In another aspect, rather than failing the outstanding operation of core 0, the request from L2 may wait until core 0 performs a store conditional before transferring the ownership to core 1. In this aspect in one embodiment, a timeout is used to prevent deadlock. After a period of time, core 0 moves forward and responds to the request from L2 to return ownership, and then fail the outstanding store conditional when it arrives.

At 308, core 1 can complete the operation on the address.

The primary difference between the embodiments illustrated in FIG. 2 and FIG. 3 is whether, upon a request ownership of the address is returned to L2 or given directly to the other core requesting the address. Depending on the expected behavior of a particular application, or even data structure within an application, one may be preferable over the other. Consequently, the embodiment provides for a mechanism for the application to choose the implementation by setting a set of bits in the L2 associated with a range of addresses the application desires that implementation to be in effect on. Because, while for many data structures or application behavior this embodiment may be preferable, but for some, the original implementation of atomic operations may be preferable, this embodiment provides for one of the bit settings to cause the original behavior to be used.

The default behavior implemented can be any of the above described embodiments or the original. The user of the atomic operations does not need to do anything other than use the atomic operations in the normal manner to obtain the default behavior. If the user wishes a different behavior to a particular range of addresses it sets the bit values associated with that range.

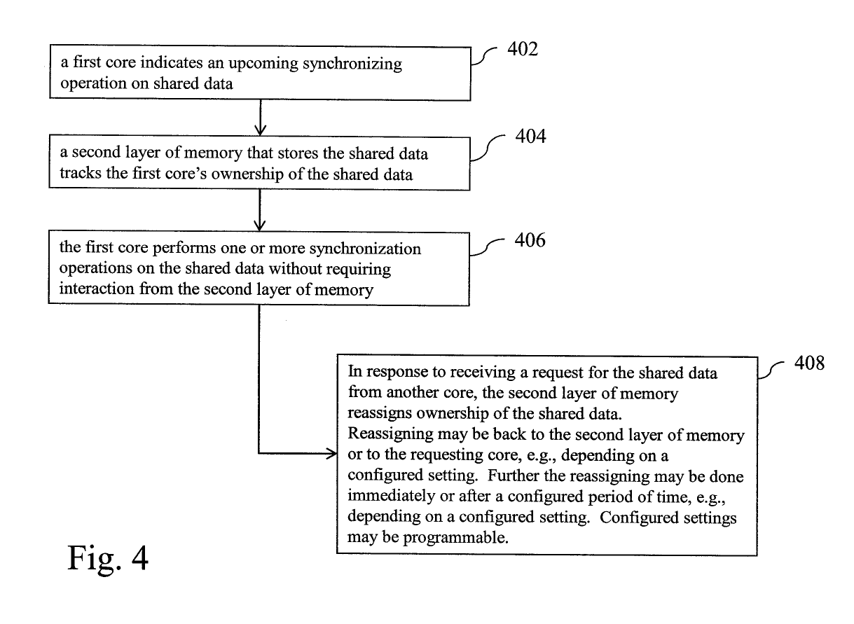

FIG. 4 is a flow diagram illustrating a method of performing a series of successive synchronizing operations by a core on data shared by a plurality of cores in one embodiment of the present disclosure. At 402, a first core indicates an upcoming synchronizing operation on shared data. A synchronizing operation, for example, includes an atomic operation. At 404, a second layer of memory that stores the shared data tracks the first core's ownership of the shared data. The second layer, of memory is memory shared via coherency operations among the first core and one or more second cores. Once the second layer of memory gives the ownership to the first core, the first core brings in the data from the second layer of memory into its first layer of memory. At 406, the first core performs one or more synchronization operations on the shared data without requiring interaction from the second layer of memory.

In one aspect, the one or more second cores are located on the same chip as the first core. In another aspect, the first core and the one or more second cores may be located on different chips.

At 408, the second layer of memory may receive a request for the shared data from another core, for example, a second core. In response, the second layer of memory reassigns ownership of the shared data. In one embodiment, the second layer of memory may immediately reclaim ownership from the first core and the first core fails any successive store conditionals. In another embodiment, the second layer of memory may immediately assign ownership to the second core.

In reassigning ownership, the second layer of memory may wait up to a configurable timeout value for the first core to finish its operations on the shared data before taking ownership. The configurable timeout value may be preset or preprogrammed or dynamically programmed.

In another aspect, a set of configuration bits may be set per a range of or a set of addresses in the second layer of memory for indicating or programming the different embodiment of behavior of assigning the ownership of the data in those sets of addresses, that is, whether to immediately reclaim ownership back to the second layer of memory, whether to immediately assign ownership from the first core to the second core, whether to wait a configurable timeout value before reassigning ownership either back to the second layer of memory or the second core, or combinations thereof.

Yet in another aspect, the second layer of memory may keep a queue of requesting cores.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of performing a series of successive synchronizing operations by a core on data shared by a plurality of cores, comprising:
a first core indicating an upcoming synchronizing operation on shared data;
a second layer of memory that stores the shared data tracking the first core's ownership of the shared data, the second layer of memory being shared via coherency operations among the first core and one or more second cores; and
the first core performing one or more synchronization operations on the shared data without requiring interaction from the second layer of memory.

2. The method of claim 1, wherein the first core includes a first layer of memory that is located closer to the first core than the second layer of memory, and wherein the one or more synchronization operations are performed on the shared data by bringing in the shared data from the second layer of memory to the first layer of memory.

3. The method of claim 1, wherein the one or more second cores are located on the same chip as the first core.

4. The method of claim 1, wherein the one or more second cores are located on a different chip than the first core.

5. The method of claim 1, wherein in response to receiving a request for the shared data from a second core, the second layer of memory reassigns ownership of the shared data.

6. The method of claim 5, wherein the second layer of memory immediately reclaims ownership from the first core and the first core fails any successive store conditionals.

7. The method of claim 5, wherein the second layer of memory immediately assigns ownership to said second core.

8. The method of claim 5, wherein the second layer of memory waits up to a configurable timeout value for the first core to finish its operations on the shared data before taking ownership.

9. The method of claim 5, wherein a set of configuration bits per a set of addresses sets a behavior of assigning an ownership for said set of addresses.

10. The method of claim 5, wherein the second layer of memory keeps a queue of requesting cores.

11. A system for performing a series of successive synchronizing operations by a core on data shared by a plurality of cores, comprising:
a plurality of cores on one or more chips, each of the plurality of cores having an associated first layer of memory, the plurality of cores operable to indicate an upcoming synchronization operation on shared data;
a second layer of memory shared between the plurality of cores and operable to store the shared data, the second layer of memory further operable to keep track of which core currently owns the shared data, wherein
the plurality of cores are operable to perform one or more synchronization operations on the shared data without requiring interaction from the second layer of memory by bringing in the shared data from the second layer of memory to the first layer of memory.

12. The system of claim 11, wherein the one or more synchronization operations are atomic operation.

13. The system of claim 11, wherein the plurality of cores are located on the same chip.

14. The system of claim 11, wherein the plurality of cores are located on different chips.

15. The system of claim 11, wherein the second layer of memory reassigns ownership of the shared data from a first of the plurality of cores to a second of the plurality of cores in response to receiving a request from said second of the plurality of cores for the shared data.

16. The system of claim 15, wherein the second layer of memory immediately reclaims ownership from the first of the plurality of cores and the first of the plurality of cores fails any successive store conditionals.

17. The system of claim 15, wherein the second layer of memory immediately assigns ownership to said second of the plurality of cores.

18. The system of claim 15, wherein the second layer of memory waits up to a configurable timeout value for the first of the plurality of cores to finish its operations on the shared data before taking ownership.

19. The system of claim 15, wherein a set of configuration bits per a set of addresses sets a behavior of assigning an ownership for said set of addresses.

20. The system of claim 15, wherein the second layer of memory keeps a queue of requesting cores.

21. A computer readable storage medium storing a program of instructions executable by a machine to perform a
method of performing a series of successive synchronizing operations by a core on data shared by a plurality of cores, comprising:
a first core indicating an upcoming synchronizing operation on shared data;
a second layer of memory that stores the shared data tracking the first core's ownership of the shared data, the second layer of memory being shared via coherency operations among the first core and one or more second cores; and
the first core performing one or more synchronization operations on the shared data without requiring interaction from the second layer of memory.

22. The computer readable storage medium of claim 21, wherein the first core includes a first layer of memory that is located closer to the first core than the second layer of memory, and wherein the one or more synchronization operations are performed on the shared data by bringing in the shared data from the second layer of memory to the first layer of memory.

23. The computer readable storage medium of claim 21, wherein in response to receiving a request for the shared data from a second core, the second layer of memory reassigns ownership of the shared data.

24. The computer readable storage medium of claim 23, wherein the second layer of memory immediately reclaims ownership from the first core and the first core fails any successive store conditionals.

25. The computer readable storage medium of claim 23, wherein the second layer of memory immediately assigns ownership to said second core.
